(19) United States
(12) Patent Application Publication
(10) Pub. No.: US 2003/0058224 A1
(43) Pub. Date: Mar. 27, 2003

(54) Moving image playback apparatus, moving image playback method, and audio playback apparatus

(76) Inventor: Chikara Ushimaru, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/233,498

(22) Filed: Sep. 4, 2002

(30) Foreign Application Priority Data
Sep. 18, 2001 (JP) 2001-284103

(51) Int. Cl. G09G 5/00

(52) U.S. Cl. 345/169

(57) ABSTRACT

When a moving image playback apparatus according to the present invention is to play back a moving image in synchronism with an audio playback apparatus, the apparatus acquires playback position information of audio from the audio playback apparatus via a communication unit in a predetermined cycle. The apparatus detects the synchronization error amount between the moving image and the audio, and the motion of the moving image. The apparatus specifies a scene where the frame rate is to be changed and a frame rate change amount under a predetermined rule in accordance with the synchronization error amount and the motion of the moving image. The apparatus changes the moving image frame display time and the frame rate such as the skip number of frames within a small-motion-change scene hardly perceived by a viewer.

### CROSS-REFERENCE TO RELATED APPLICATIONS

This application is based upon and claims the benefit of priority from the prior Japanese Patent Application No. 2001-284103, filed Sep. 18, 2001, the entire contents of which are incorporated herein by reference.

### BACKGROUND OF THE INVENTION

1. Field of the Invention

The present invention relates to a moving image playback apparatus, moving image playback method, and audio playback apparatus for playing back a moving image and audio by different apparatuses.

2. Description of the Related Art

As a method of detecting the motion of a scene contained in a moving image and controlling the frame rate in accordance with the detected motion in a moving image playback apparatus, a variable-frame-rate moving image encoding method disclosed in Jpn. Pat. Appln. KOKAI Publication No. 9-168155 and a moving image encoding apparatus disclosed in Jpn. Pat. Appln. KOKAI Publication No. 5-22710 are proposed.

Jpn. Pat. Appln. KOKAI Publication No. 9-168155 discloses a moving image encoding method using a variable frame rate. According to this method, motion compensation is performed for the macro block of a preceding frame by using a motion vector. A prediction error is calculated as the difference between the motion-compensated macro block and the macro block of a current frame to be encoded. The calculated prediction error is compared with a threshold to determine whether the macro block to be encoded is an insignificant macro block smaller than the threshold or a significant macro block larger than the threshold. If the target macro block is a significant one, the macro block is encoded; if the target macro block is an insignificant one, only the motion vector is transmitted. The ratio of significant macro blocks to insignificant macro blocks in the current frame is calculated, and the skip number of frames from the current frame to the next frame to be encoded is determined based on the calculated ratio. In this manner, moving images are encoded at a variable frame rate.

Jpn. Pat. Appln. KOKAI Publication No. 5-22710 relates to an apparatus for encoding each frame of an input moving image signal by variable-length coding, and transmitting the encoded frame to another apparatus. This apparatus detects the motion of an input moving image, and does not transmit only the number of frames determined in advance in accordance with the detected motion amount.

In the inventions of Jpn. Pat. Appln. KOKAI Publication Nos. 9-168155 and 5-22710, the motion of an input moving image is detected to encode the image in accordance with the detected motion or to change the transmission frame rate. The purposes of these inventions are to generate a moving image with small degradation in image quality or to suppress the code amount to be transmitted. These inventions do not change the frame rate for synchronization in order to synchronously play back a moving image and audio in different apparatuses.

When a moving image and audio are synchronously played back in different apparatuses, i.e., a moving image playback apparatus and audio playback apparatus, moving image playback timing control and audio playback timing control refer to different clocks, which causes errors. That is, the moving image and audio have a time lag.

### BRIEF SUMMARY OF THE INVENTION

The present invention has been made to overcome the conventional drawbacks, and has as its embodiments to provide a moving image playback apparatus and moving image playback method which do not give a viewer any unnatural impression by detecting the motion of a scene in a moving image and changing the display time of a moving image frame or the frame rate such as the skip number of frames within a scene hardly perceived by the viewer.

It is another embodiments of the present invention to provide an audio playback apparatus capable of transmitting, via a communication means, information representing an audio playback position in response to a request from the moving image playback apparatus.

To achieve the above embodiments, according to the present invention, there is provided a moving image playback apparatus comprising communication means for communicating with another apparatus, synchronization error detection means for communicating with another apparatus via the communication means in a predetermined cycle, acquiring a playback position of audio data of the another apparatus, and detecting a synchronization error amount between the audio data and moving image data corresponding to the audio data, frame rate control means for determining a frame rate change amount in accordance with the detected synchronization error amount, decoding means for decoding the encoded moving image data and playing back the moving image data, motion detection means for detecting a motion of a moving image on the basis of the moving image data decoded by the decoding means, and frame rate change means for changing a frame rate of the moving image in accordance with the frame rate change amount determined by the frame rate control means on the basis of a detection result of the motion detection means.

In this arrangement, when the moving image playback apparatus is to play back a moving image in synchronism with another apparatus such as an audio playback apparatus, the moving image playback apparatus acquires playback position information of audio from the audio playback apparatus via the communication unit in a predetermined cycle. The synchronization error detection means detects the synchronization error amount between the moving image and the audio, and the motion detection means detects the motion of the moving image. The frame rate control means specifies a scene where the frame rate is to be changed and a frame rate change amount under a predetermined rule in accordance with the synchronization error amount and the motion of the moving image. The frame rate change means changes the moving image frame display time and the frame rate such as the skip number of frames within a small-motion-change scene hardly perceived by a viewer in accordance with the frame arte change amount determined by the frame rate control means. A Synchronization error between apparatuses can be eliminated when a moving image and audio are synchronously played back in different apparatuses. Synchronization processing can be executed without giving any unnatural impression to a viewer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view schematically showing a moving image playback apparatus and audio playback apparatus according to an embodiment of the present invention;

FIG. 2 is a block diagram showing a detailed arrangement of the moving image playback apparatus in the embodiment;

FIG. 3 is a flow chart showing processing of changing the frame rate and eliminating a synchronization error in the embodiment; and

FIG. 4 is a table showing an example of a rule for determining the frame rate change amount in the embodiment.

### DETAILED DESCRIPTION OF THE INVENTION

A preferred embodiment of the present invention will be described in detail below with reference to the several views of the accompanying drawing.

FIG. 1 is a view showing the schematic arrangements of a moving image playback apparatus and audio playback apparatus according to the embodiment of the present invention. In this embodiment, a moving image playback apparatus 10 plays back a moving image in synchronism with audio played back by an audio playback apparatus 11. The moving image playback apparatus 10 and audio playback apparatus 11 are, e.g., portable. The moving image playback apparatus 10 plays back moving image data stored in advance in an internal memory or a memory card inserted in a slot, or moving image data transmitted from a server (not shown). Then, the moving image playback apparatus 10 displays the playback data on a display unit 25.

The moving image playback apparatus 10 has a communication means and antenna 12 for wireless communication or the like. When moving image data is stored in advance in the internal memory or memory card, the moving image playback apparatus 10 reads out encoded moving image data and audio data which are stored in the memory. The apparatus 10 executes moving image playback processing while transmitting the audio data to the audio playback apparatus 11. The moving image playback apparatus 10 reads out current playback position information from the audio playback apparatus 11 in a predetermined cycle. The apparatus 10 detects the synchronization error amount and the motion of the moving image. The apparatus 10 changes the display time of the moving image frame and the frame rate such as the skip number of frames within a small-motion-change scene hardly perceived by a viewer. Thus, the apparatus 10 achieves synchronization processing with the audio playback apparatus 11.

The audio playback apparatus 11 has a communication means and antenna 13 for wireless communication or the like. The apparatus 11 plays back audio data transmitted from the moving image playback apparatus 10 or audio data transmitted from a server (not shown), and outputs the audio data from a loudspeaker, earphone, or the like. The audio playback apparatus 11 comprises a playback position measurement means for measuring the playback position of an audio portion. The playback position measurement means can measure, e.g., a lapsed time from the start of audio playback, and output the measured time as playback position information. The audio playback apparatus 11 transmits current playback position information measured by the playback position measurement means to the moving image playback apparatus 10 via the communication means in response to a request from the moving image playback apparatus 10.

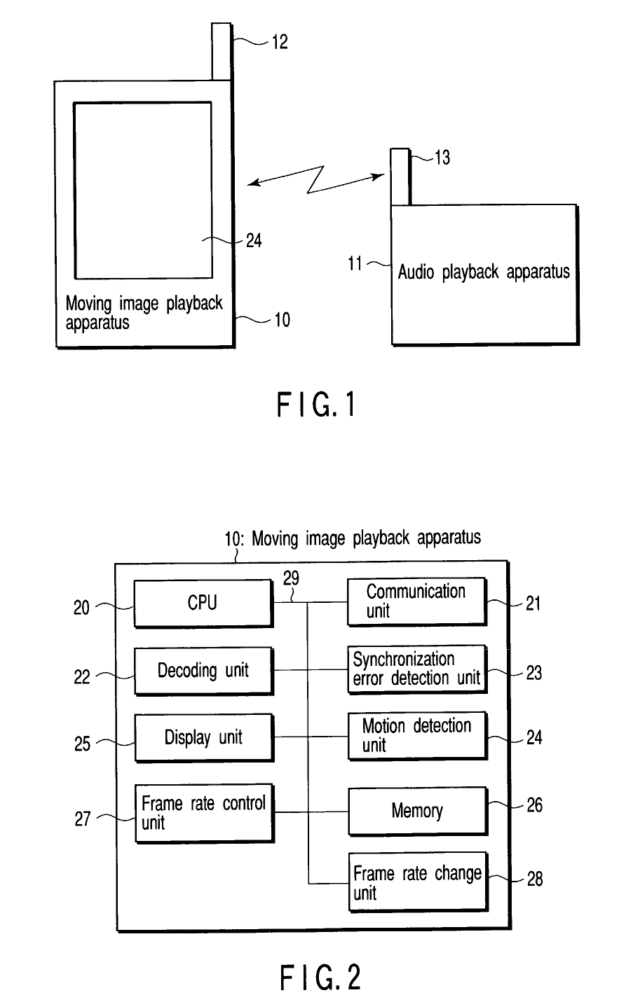

A detailed arrangement of the moving image playback apparatus 10 will be explained with reference to FIG. 2. The moving image playback apparatus 10 comprises a CPU 20 which controls the whole apparatus 10, a communication unit 21 through which the apparatus 10 communicates with another apparatus such as the server or audio playback apparatus 11, a decoding unit 22 which decodes encoded moving image data, a synchronization error detection unit 23 which detects the amount of synchronization error from another apparatus, a motion detection unit 24 which detects the motion of a scene within a moving image, the display unit 25 which displays a moving image frame decoded by the decoding unit 22, a memory 26 which stores program data and moving image data, a frame rate control unit 27 which determines a frame rate change amount in accordance with a synchronization error and the motion of a moving image, and a frame rate change unit 28 which changes the frame rate by the change amount determined by the frame rate control unit 27. These units are connected by a bus line 29. The memory 26 stores moving image data encoded by MPEG4 or the like. Note that moving image data may be stored in, e.g., a card memory inserted in a card slot other than the memory 26.

The CPU 20 executes programs stored in the memory 26 to implement various functions. The CPU 20 integrally controls the following units of the apparatus.

A moving image is played back by decoding moving image data stored in the memory 26 or moving image data sent from the server by the decoding unit 22, and displaying the decoded data on the display unit 25. At this time, the CPU 20 controls the playback timing of the moving image frame.

A synchronization error occurs because different clocks are referred to for controlling the moving image playback timing of the moving image playback apparatus 10 and controlling the audio playback timing of the audio playback apparatus 11. To eliminate a synchronization error, the moving image playback apparatus 10 communicates with the audio playback apparatus 11 via the communication unit 21, and periodically acquires audio playback position information of the audio playback apparatus 11. Then, the apparatus 10 displays a moving image frame corresponding to the acquired audio playback position.

If a currently played-back moving image frame does not correspond to an audio playback position acquired from the audio playback apparatus 11, the moving image playback apparatus 10 eliminates a synchronization error by changing the playback time of the moving image frame or skipping the moving image frame by the frame rate change unit 28. At this time, the motion detection unit 24 detects the motion of a scene within a moving image, and the frame rate control unit 27 determines a frame rate change amount in accordance with the detected motion.

When the motion detected by the motion detection unit 24 is large, changing the display time of a moving image frame or the frame rate such as the skip number of moving image frames may give a viewer an unnatural impression. For a small-change motion, the viewer hardly has an unnatural impression even if the frame rate is changed. The frame rate is, therefore, changed in a small-motion-change scene. If, however, the motion of a moving image has a predetermined value or more within a predetermined number of frames, that is, if a predetermined or larger number of large-motion-change scenes succeed for several sec, the frame rate is immediately changed to eliminate a synchronization error.

The motion detection unit 24 detects a motion as follows. That is, the motion detection unit 24 calculates an average absolute error between moving image frames decoded by the decoding unit 22 at two different times, and evaluates the motion amount stepwise in accordance with a predetermined value. Alternatively, the motion detection unit 24 may evaluate the motion amount of a moving image on the basis of the frame size of moving image data before decoding. For example, for MPEG4, the motion detection unit 24 evaluates the motion amount of a moving image by using the code amount of a P picture as a criterion representing the difference between preceding and current frames.

If the synchronization error detection unit 23 detects a synchronization error as a result of communication with the audio playback apparatus 11 via the communication unit 21, the frame rate control unit 27 determines a frame rate change amount under a predetermined rule in accordance with the motion amount detected by the motion detection unit 24.

The moving image playback apparatus 10 makes the playback position of a moving image correspond to that of an audio portion in order to eliminate a synchronization error. When the playback position of an audio portion advances from that of a moving image, the display time of the moving image frame is shortened or frames are skipped forward, thereby eliminating a synchronization error. When the playback position of an audio portion delays from that of a moving image, the display time of the moving image frame is prolonged or frames are skipped backward, eliminating a synchronization error.

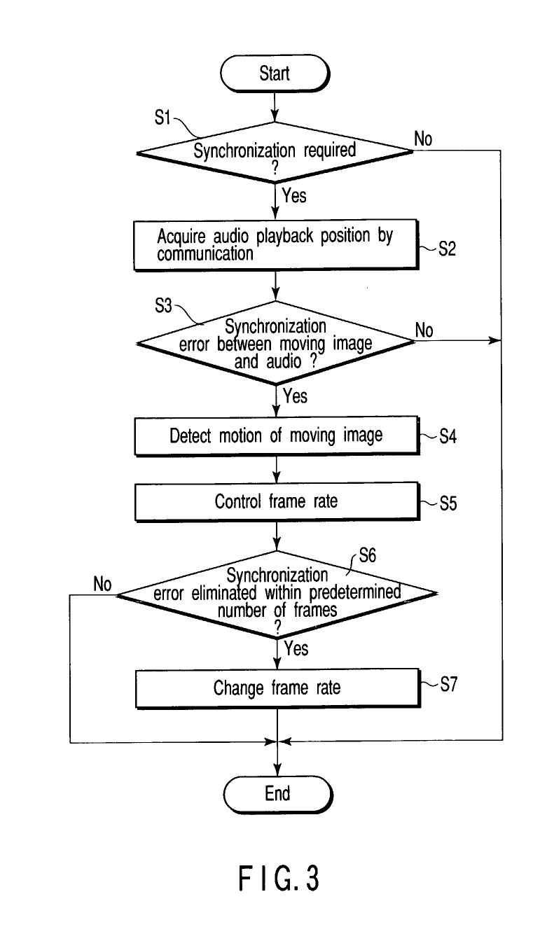

Frame rate change operation of the moving image playback apparatus 10 will be explained. FIG. 3 is a flow chart showing a sequence of detecting a synchronization error between an image and audio and changing the frame rate in the moving image playback apparatus 10.

The moving image playback apparatus 10 plays back a moving image in synchronism with an audio portion played back by the audio playback apparatus 11. This synchronization processing is executed every predetermined time interval. The time interval is set to, e.g., about 10 to 20 sec, which changes depending on the clock precision. The moving image playback apparatus 10 measures the lapse of time from the last synchronization processing, and determines from the lapsed time whether to establish synchronization (step S1).

If the lapsed time from the last synchronization processing is a predetermined time or longer, the CPU 20 acquires via the communication unit 21 playback position information of a currently played-back audio portion in the audio playback apparatus 11 (step S2).

The CPU 20 controls the synchronization error detection unit 23 to compare the playback position of the audio in the audio playback apparatus 11 that is acquired in step S2 with the playback position of the moving image. The CPU 20 checks whether a synchronization error occurs between the moving image and the audio portion, and determines a synchronization error amount (step S3). If NO in step S3, or even if YES in step S3 but the synchronization error is too small to perceive by a viewer, the CPU 20 determines that no synchronization error occurs, and ends synchronization processing.

If YES in step S3, the motion detection unit 24 performs motion detection between each moving image frame and a moving image frame at preceding time, for all the moving image frames from the playback position of a currently played-back moving image up to the playback position of a moving image corresponding to that of the audio portion acquired in step S2 (step S4).

The CPU 20 specifies a scene where the frame rate is to be changed, and a frame rate change amount under a predetermined rule in accordance with the synchronization error amount detected in step S3 and the motions of moving images detected in step S4 (step S5).

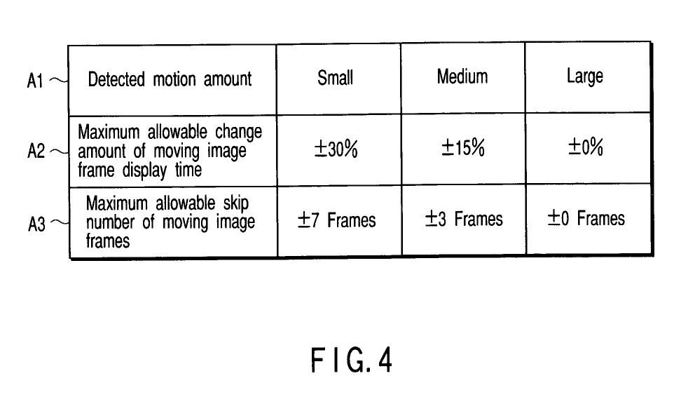

FIG. 4 shows an example of a rule used to determine a frame rate change amount from the motions of moving images detected in step S4. A field A1 on the first row of the rule shown in FIG. 4 represents the motion amount of a moving image detected in step S4. In this example, three amounts “small”, “medium”, and “large” are set. These amounts “small”, “medium”, and “large” are defined based on a predetermined threshold or a threshold set by the user. A field A2 on the second row of the rule represents the maximum allowable change amount of the moving image frame display time corresponding to each of the motion amounts of moving images in the field A1 on the first row. The maximum allowable change amount is “±30%” for the motion amount “small”, “±15%” for “medium”, and “±0%” for “large”. A field A3 on the third row of the rule represents the maximum allowable frame skip number of moving image frames corresponding to each of the motion amounts of moving images in the field A1 on the first row. The maximum allowable frame skip number of moving image frames is “±7 frames” for the motion amount “small”, “±3 frames” for “medium”, and “±0” for “large”.

The maximum allowable change amount of the moving image frame display time in the field A2 on the second row of the rule and the maximum allowable frame skip number of moving image frames in the field A3 on the third row are set to take larger values for a smaller motion amount of a moving image and smaller values for a larger motion amount. The frame rate is changed a plurality of number of times until a synchronization error between a moving image and audio is eliminated. If the synchronization error cannot be eliminated within a predetermined number of frames, the number of frames enough to eliminate the synchronization error are immediately skipped (steps S6 and S7). If the synchronization error is eliminated, the processing ends.

To eliminate the synchronization error between an image and audio, the moving image playback apparatus 10 makes the moving image correspond to the playback position of the audio portion. If the playback position of the moving image delays from that of the audio portion, the display time of the moving image frame is shortened or frames are skipped forward, thus eliminating a synchronization error. If the playback position of the moving image advances from that of the audio portion, the display time of the moving image frame is prolonged or frames are skipped backward, eliminating a synchronization error. The frame rate is changed by the frame rate change amount determined in step S5 (step S6).

In this fashion, when the separately arranged moving image playback apparatus 10 and audio playback apparatus 11 are to perform playback operation, the moving image playback apparatus 10 acquires playback position information of the audio playback apparatus 11 to synchronously play back a moving image. The change of the frame rate for eliminating a synchronization error is performed by the moving image playback apparatus 10 in a hardly perceived small-motion-change scene obtained by detecting the motions of moving images. The frame rate can be changed without giving any unnatural impression to a viewer.

In the above embodiment, a frame rate change amount is determined in step S7 under a predetermined rule in accordance with the synchronization error amount detected in step S3 and the motions of moving images detected in step S4. It is also possible to determine a frame rate change amount in accordance with, e.g., the synchronization error amount, specify a scene, the frame rate change of which is hardly perceived by a viewer from the motions of moving images, and change the frame rate.

As has been described in detail above, according to the present invention, a synchronization error is detected in a predetermined cycle when the synchronization error occurs because synchronization is difficult to establish at a satisfactory frequency in synchronous playback in a case in which a moving image and audio are synchronously played back in different apparatuses. The motions of moving images are detected, and the frame rate is changed in a scene, the frame rate change of which is hardly perceived by a viewer. Synchronization processing can be executed without giving any unnatural impression to a viewer.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A moving image playback apparatus comprising:
means for communicating audio data with another apparatus;
means for detecting a synchronization error amount between the audio data and moving image data corresponding to the audio data;
means for determining a frame rate change amount in accordance with the detected synchronization error amount; and
means for controlling a frame rate of the moving image in accordance with the frame rate change amount determined.

2. A moving image playback apparatus comprising:
means for communicating with another apparatus;
means for communicating with another apparatus via said communication means in a predetermined cycle, and acquiring a playback position of audio data of said another apparatus;
means for detecting a synchronization error amount between the audio data and moving image data corresponding to the audio data;
means for decoding the encoded moving image data and playing back the moving image data;
means for detecting a motion of a moving image on the basis of the moving image data decoded;
means for determining, in accordance with the synchronization error amount detected and the motion of the moving image detected, a frame rate change amount and a scene where a frame rate is to be changed; and
means for controlling the frame rate of the moving image in a scene determined, thereby synchronizing a playback position of the moving image with the playback position of the audio data.

3. An apparatus according to claim 1, wherein said motion detection means compares moving image frames at two times decoded, thereby detecting a motion.

4. An apparatus according to claim 1, wherein said motion detection means calculates a size of each encoded moving image frame from encoded moving image data, and detects a motion by using the calculated frame size as a reference.

5. An apparatus according to claim 1, wherein said frame rate control means determines a change amount of a moving image frame display time in accordance with the synchronization error amount between said moving image playback apparatus and said another apparatus that is detected.

6. An apparatus according to claim 1, wherein said frame rate control means determines the number of frames by which moving image frames are to be skipped in accordance with the synchronization error amount between said moving image playback apparatus and said another apparatus that is detected.

7. An apparatus according to claim 1, wherein said frame rate control means determines a change amount of a moving image frame display time in accordance with the motion of the moving image detected.

8. An apparatus according to claim 1, wherein said frame rate control means determines, in accordance with the motion of the moving image detected, the number of frames by which moving image frames are to be skipped.

9. An apparatus according to claim 1, wherein said frame rate control means determines, as the skip number of moving image frames, the number of frames enough to eliminate the synchronization error detected when the motion detected is not less than a predetermined value within a predetermined number of frames.

10. An apparatus according to claim 1, wherein said frame rate change means changes a moving image frame display time in accordance with a change amount of the moving image frame display time determined.

11. An apparatus according to claim 1, wherein said frame rate change means skips moving image frames in accordance with the number of frames which is determined and by which moving image frames are to be skipped.

12. An apparatus according to claim 1, wherein said another apparatus includes an audio playback apparatus.

13. An apparatus according to claim 1, further comprising:
means for communicating with another apparatus via said communication means in a predetermined cycle, acquiring a playback position of audio data of said another apparatus.

14. An apparatus according to claim 1, further comprising:
means for decoding the encoded moving image data and playing back the moving image data; and
means for detecting a motion of a moving image on the basis of the moving image data decoded.

15. A moving image playback method comprising:
communicating with another apparatus in a predetermined cycle, acquiring a playback position of audio data of said another apparatus, and detecting a synchronization error amount between the audio data and moving image data corresponding to the audio data;
determining a frame rate change amount in accordance with the detected synchronization error amount;
decoding the encoded moving image data and playing back the moving image data;
detecting a motion of a moving image on the basis of the moving image data decoded in the decoding step; and
changing a frame rate of the moving image in accordance with the frame rate change amount determined in a scene determined by a detection result of the motion detection step.

16. A moving image playback method comprising:
communicating with another apparatus;
communicating with another apparatus in the communication step in a predetermined cycle, and acquiring a playback position of audio data of said another apparatus,
detecting a synchronization error amount between the audio data and moving image data corresponding to the audio data;
decoding the encoded moving image data and playing back the moving image data;
detecting a motion of a moving image on the basis of the moving image data decoded in the decoding step;
determining a frame rate change amount in accordance with the synchronization error amount detected in the synchronization error detection step and the motion of the moving image detected in the motion detection step; and
changing the frame rate of the moving image by the frame rate change amount determined, thereby synchronizing a playback position of the moving image with the playback position of the audio data.

17. A method according to claim 15, wherein in the motion detection step, moving image frames at two times decoded in the decoding step are compared to detect a motion.

18. A method according to claim 15, wherein in the motion detection step, a size of each encoded moving image frame is calculated from encoded moving image data, and a motion is detected using the calculated frame size as a reference.

19. A method according to claim 15, wherein a change amount of a moving image frame display time is determined in accordance with the synchronization error amount from said another apparatus that is detected in the synchronization error detection step.

20. A method according to claim 15, wherein the number of frames by which moving image frames are to be skipped is determined in accordance with the synchronization error amount from said another apparatus that is detected in the synchronization error detection step.

21. A method according to claim 15, wherein a change amount of a moving image frame display time is determined in accordance with the motion of the moving image detected in the motion detection step.

22. A method according to claim 15, wherein the number of frames by which moving image frames are to be skipped is determined in accordance with the motion of the moving image detected in the motion detection step.

23. A method according to claim 15, wherein the number of frames enough to eliminate the synchronization error detected in the synchronization error detection step is determined as the skip number of moving image frames when the motion of the moving image detected in the motion detection step is not less than a predetermined value within a predetermined number of frames.

24. A method according to claim 15, wherein in the frame rate change step, a moving image frame display time is changed in accordance with a change amount of the moving image frame display time determined.

25. A method according to claim 15, wherein moving image frames are skipped in accordance with the number of frames which is determined and by which moving image frames are to be skipped.

26. An audio playback apparatus comprising:
means for receiving audio data transmitted from another apparatus;
means for playing back and outputting the audio data received via said communication means;
means for measuring a playback position of audio played back by said playback means; and
means for transmitting playback position information measured by said playback position measurement means via said communication means in response to a request from said another apparatus.
